(19) United States
(12) Patent Application Publication
(10) Pub. No.: US 2024/0272837 A1
(43) Pub. Date: Aug. 15, 2024

(54) PRINTING CONTROL APPARATUS, METHOD FOR PRODUCING PRINTED MATTER, AND PRINTING CONTROL PROGRAM

(71) Applicant: SEIKO EPSON CORPORATION, Tokyo (JP)

(72) Inventor: Akio TAKAMOTO, Shiojiri (JP)

(21) Appl. No.: 18/434,911

(22) Filed: Feb. 7, 2024

(30) Foreign Application Priority Data
Feb. 9, 2023 (JP) 2023-018200

(51) Int. Cl. G06F 3/12

(52) U.S. Cl. CPC G06F 3/1205; G06F 3/1253; G06F 3/1285

(57) ABSTRACT

Provided is a printing control apparatus including: an acquisition unit configured to acquire a printing job from an external computer; an identification unit configured to identify a type of a program operating in the external computer; a setting unit configured to display a setting screen corresponding to the identified type, and receive setting of a user via the setting screen; a correction unit configured to correct the printing job according to the received setting; and a printing control unit configured to cause a printer to execute printing based on the corrected printing job.

The present application is based on, and claims priority from JP Application Serial Number 2023-018200, filed Feb. 9, 2023, the disclosure of which is hereby incorporated by reference herein in its entirety.

### BACKGROUND

### 1. Technical Field

The present disclosure relates to a printing control apparatus, a method for producing a printed matter, and a printing control program.

### 2. Related Art

In the related art, printing using a printer-unique printer driver and printing using a standard printer driver of an OS are known (for example, JP-A-2021-174196).

JP-A-2021-174196 is an example of the related art.

### SUMMARY

However, when printing is performed by using a general-purpose printer driver such as the standard printer driver of the OS, it is not possible to use functions possessed only by some printer models.

A printing control apparatus for solving the problems described above includes: an acquisition unit configured to acquire a printing job from an external computer; an identification unit configured to identify a type of a program operating in the external computer; a setting unit configured to display a setting screen corresponding to the identified type, and receive setting of a user via the setting screen; a correction unit configured to correct the printing job according to the received setting; and a printing control unit configured to cause a printer to execute printing based on the corrected printing job.

A method for producing printing for solving the problems described above includes: acquiring a printing job from an external computer; identifying a type of a program operating in the external computer; displaying a setting screen corresponding to the identified type; receiving setting of a user via the setting screen; and causing a printer to produce a printed matter based on the printing job corrected according to the received setting.

A printing control program for solving the problems described above and for causing a computer to function as: an acquisition unit configured to acquire a printing job from an external computer; an identification unit configured to identify a type of a program operating in the external computer; a setting unit configured to display a setting screen corresponding to the identified type, and receive setting of a user via the setting screen; a correction unit configured to correct the printing job according to the received setting; and a printing control unit configured to cause a printer to execute printing based on the corrected printing job.

### BRIEF DESCRIPTION OF THE DRAWINGS

FIG. 1 is a block diagram of a printing system.

FIG. 2 is a block diagram of a user terminal.

FIG. 3 is a diagram showing a configuration example of a printing job.

FIG. 4 is a table showing an example of types of printers.

FIG. 5 is a block diagram of a printer.

FIG. 6 is a block diagram of a printer (print server).

FIG. 7 is a table showing an example of printing history data.

FIG. 8 is a table showing an example of Web access history data.

FIG. 9 is a table showing an example of missing setting item data.

FIG. 10 is a sequence diagram of printing control processing.

### DESCRIPTION OF EMBODIMENTS

(1) Configuration of Printing System
(1-1) Configuration of User Terminal
(1-2) Configuration of Printer
(2) Printing Control Processing
(3) Other Embodiments
(1) Configuration of Printing System

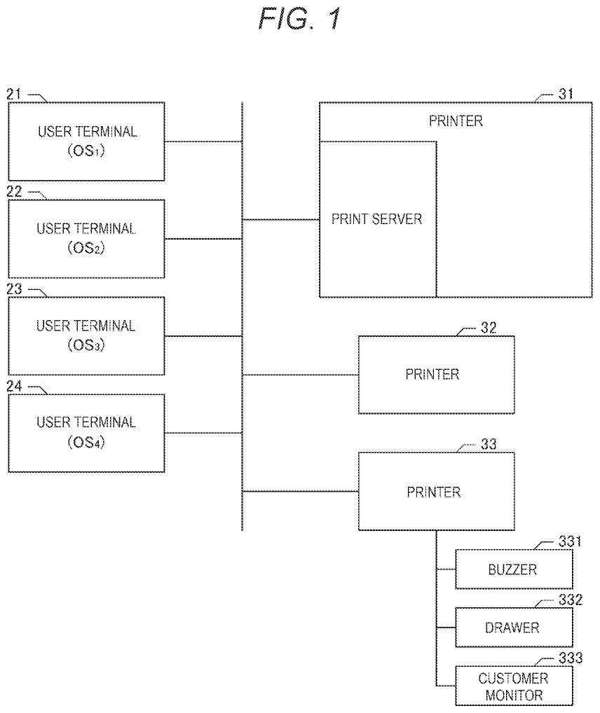

FIG. 1 is a diagram showing an example of a printing system including a printing control apparatus according to an embodiment of the present disclosure. The printing system includes a plurality of user terminals and a plurality of printers. Although four user terminals (21, 22, 23, 24) and three printers (31, 32, 33) are shown in FIG. 1, these numbers are merely examples, and the number is not limited. The user terminal is an apparatus that requests the printer to print content, and is connected to the printer via a network. A form of the network is not limited, and the network may be the Internet, a local area network (LAN), or both the Internet and the LAN may be used.

In the embodiment, a user can prepare content that is a printing target by operating any one of the user terminals, and can print the content by any one of the printers. A printer driver is used to print with a printer 20. That is, when the user instructs printing of the content by using an application program, data indicating the content is transferred to the printer driver. The user terminal uses a function of the printer driver to generate a printing job for printing content according to setting designated by the user. The application program and the printer driver are both programs that operate in an execution environment of a program called an operating system (OS) that operates in the user terminal.

There are several types of printer drivers, and examples of the printer driver include a printer-unique printer driver prepared by a manufacturer of a printer, and a standard printer driver provided by the OS that causes the user terminal to operate.

In the embodiment, if the printer-unique printer driver is used, all functions that can be executed by the printer can be used. On the other hand, the standard printer driver is a part of a module of the OS. When the OS is installed in the user terminal, the standard printer driver is also installed. When the standard printer driver is used, it is possible to generate printing data that can be printed by a plurality of models of printers provided by a plurality of manufacturers. Therefore, if the standard printer driver is used, even if the printer-unique printer driver is not installed, printing can be performed by various printers.

In the embodiment, a state is assumed in which printer drivers unique to the printers 31, 32, and 33 are not installed in the user terminals 21, 22, 23, and 24, and the OS includes the standard printer driver. In such a user terminal, printing can be performed by various printers if the standard printer driver is used. However, since the standard printer driver only supports a function that can be commonly used by the plurality of printers, a specific function of a specific printer may not be used.

Therefore, in the embodiment, for a function that can be executed by any one of the printers 31, 32, and 33 but cannot be used when the standard printer driver is used, a print server is provided such that setting for using the function can be made from the user terminal. In the embodiment, the print server is implemented in the printer 31, and the printer 31 also functions as the printing control apparatus. However, the print server may be provided independently of the printer.

Hereinafter, apparatuses that constitute the printing system described above will be described.cl (1-1) Configuration of User Terminal

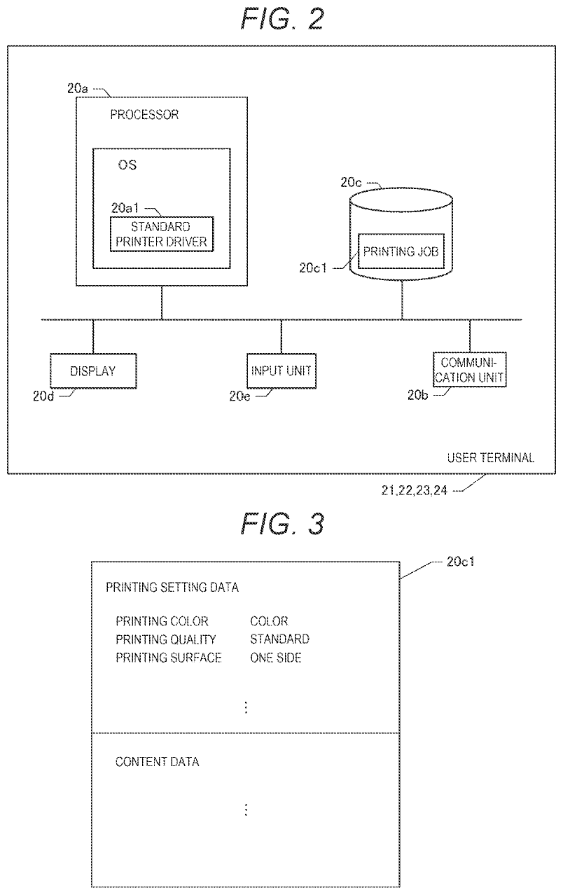

FIG. 2 is a block diagram showing configurations of the user terminals 21, 22, 23, and 24. The user terminals 21, 22, 23, and 24 are a personal computer, a smartphone, a tablet terminal, and the like. Each user terminal includes a processor 20a, a communication unit 20b, a non-volatile memory 20c, a display 20d, and an input unit 20e. The processor 20a includes a CPU, a ROM, a RAM, and the like (not shown), and can control units of the user terminal by executing various programs stored in the non-volatile memory 20c.

The communication unit 20b includes a communication interface for communicating with an external device according to various communication protocols. The user terminal can communicate with another apparatus via the communication unit 20b. The communication unit 20b may include an interface for communicating with various removable memories mounted on the user terminal.

The display 20d is a display device that displays an optional image. The input unit 20e is a device by which the user performs an input operation, and is implemented by, for example, a keyboard or a mouse when the user terminal is a stationary terminal. When the user terminal is a tablet terminal, a smartphone terminal, or the like, the input unit 20e may be implemented by a touch panel or the like. In any case, the user can operate the input unit 20e to input an intention of the user while visually recognizing an image and characters displayed on the display 20d.

When the user terminal is activated, the OS (not shown) stored in the non-volatile memory 20c is executed. Various functions such as communication or data storage of the user terminal are executed using the OS. In the embodiment, the printing function is included in functions that can be executed using the OS. That is, the OS according to the embodiment includes a standard printer driver 20a1. Further, in the user terminal, an application program (not shown) stored in the non-volatile memory 20c can be executed while using a function of the OS.

Under execution of various application programs, the user can operate the input unit 20e to issue a printing instruction in which optional content is set as a printing target. At this time, the processor 20a controls the display 20d by a function of the standard printer driver 20a1 to display an input screen of printing setting. The user operates the input unit 20e to input printing setting and issue a printing instruction.

When the printing instruction is issued, the processor 20a uses the function of the standard printer driver 20a1 to generate a printing job 20c1 for performing printing according to input setting. As shown in FIG. 3, in the embodiment, the printing job 20c1 includes printing setting data, and content data indicating content to be printed. In the printing setting data, information (setting value) indicating setting content of each item is associated with a setting item indicating a type of printing setting. For example, in a setting item of a printing surface, it is set whether to perform printing on one surface or both surfaces of a printing medium. The content data includes image data indicating content, character font data, and the like.

The user terminal according to the embodiment can use the function of the standard printer driver 20a1 to execute printing at the printers 31, 32, and 33. The printing based on the standard printer driver 20a1 is printing not using printer drivers unique to the printers (31, 32, and 33).

Since the printing based on the standard printer driver is printing not using the printer-unique printer driver, not all executable functions can be used in each of the printers 31, 32, and 33. Therefore, in the embodiment, as will be described later, the present disclosure is configured such that a setting item that cannot be set by the standard printer driver 20a1 can be set via the print server.

### (1-2) Configuration of Printer

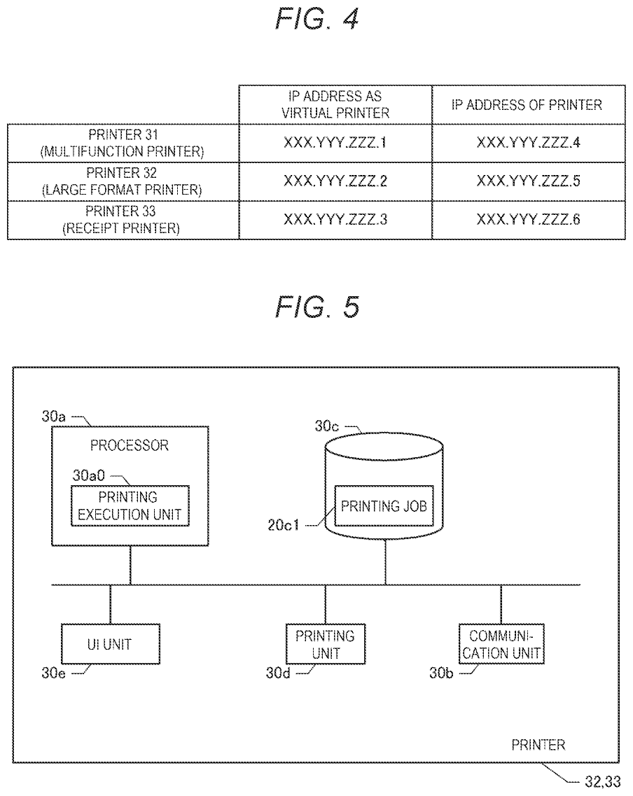

In the embodiment, the printer 31 that can also function as the print server (printing control apparatus) in addition to the function of executing printing based on the printing job 20c1, and the printers 32 and 33 that execute printing based on the printing job 20c1 under control of the print server are provided. In the embodiment, for example, as shown in FIG. 4, it is assumed that the printer 31 is a multifunction printer that can print a document, a photograph, and the like, the printer 32 is a large format printer that prints an image on a large printing medium such as a poster, and the printer 33 is a small-sized receipt printer that prints a receipt or a coupon on roll paper.

First, configurations of the printers 32 and 33 that operate under the control of the print server will be described with reference to FIG. 5. Each of the printers 32 and 33 includes a processor 30a, a communication unit 30b, a non-volatile memory 30c, a printing unit 30d, and a UI unit 30e. The processor 30a includes a CPU, a ROM, a RAM, and the like (not shown), and can control the units of the printer 32 (or the printer 33) by executing various programs stored in the non-volatile memory 30c.

The processor 30a may be implemented by a single chip, may be implemented by a plurality of chips, or may be implemented as an SoC with various functional blocks. Further, for example, an ASIC may be adopted instead of using the CPU, or the CPU and the ASIC may cooperate with each other. When each apparatus according to the embodiment includes a processor, the processor can be implemented in various forms similar to that of the processor 30a.

The communication unit 30b includes a communication interface for communicating with an external device according to various communication protocols. The printer 32 (or the printer 33) can communicate with another apparatus via the communication unit 30b. The communication unit 30b may include an interface for communicating with various removable memories mounted on the printer 32 (or the printer 33). Further, in the embodiment, the printer 33 is assumed to be a receipt printer, and is coupled to a buzzer 331 (see FIG. 1), a drawer 332, and a customer monitor 333 that are peripheral devices of the receipt printer via the communication unit 30b. The processor 30a can sound the buzzer 331, open the drawer 332, display a price on the customer monitor 333, and the like via the communication unit 30b.

The printing unit 30d is a portion for executing printing, and prints content on a printing medium. A printing method is not limited, and various methods such as an inkjet method, a toner method, and a thermal method can be adopted. Further, the printing medium may be various printing media such as cut paper and roll paper. The printing unit 30d includes an actuator, various devices, sensors, drive circuits, mechanical components, and the like for executing printing on various printing media. Further, the printing unit 30d may be able to implement various functions related to printing. For example, the printing unit 30d may include a cutting mechanism that cuts the roll paper after printing.

The UI unit 30e includes at least any one of a touch panel display, various keys, switches, LEDs, and the like. The touch panel display includes a display panel that displays various pieces of information, for example, a status of the printer 31 and a remaining amount of ink, and a touch detection panel overlaid at the display panel, and detects a touch operation. The LED performs lighting or blinking display showing a status and the like of the printer 30. The processor 30a can acquire operation content of the user via the UI unit 30e.

Various pieces of data are stored in the non-volatile memory 30c. For example, the printing job 20c1 transmitted from the user terminal can be temporarily stored.

The processor 30a uses a function of a printing execution unit 30a0 to control the printing unit 30d to execute printing based on the acquired printing job 20c1. In the embodiment, the printing job 20c1 generated by any one of the user terminals and corrected by a function of the print server (addition of a setting item that cannot be set by the standard printer driver) is acquired from the print server, and the printing unit 30d is controlled to print content data based on an operation instruction based on the printing setting data included in the printing job 20c1. As a result, the printed matter is produced. Cutting of the roll paper and control of the peripheral devices of the printer 33 are performed according to control of the processor 30a (printing execution unit 30a0) based on the setting items and the setting values thereof included in the printing setting data of the printing job 20c1.

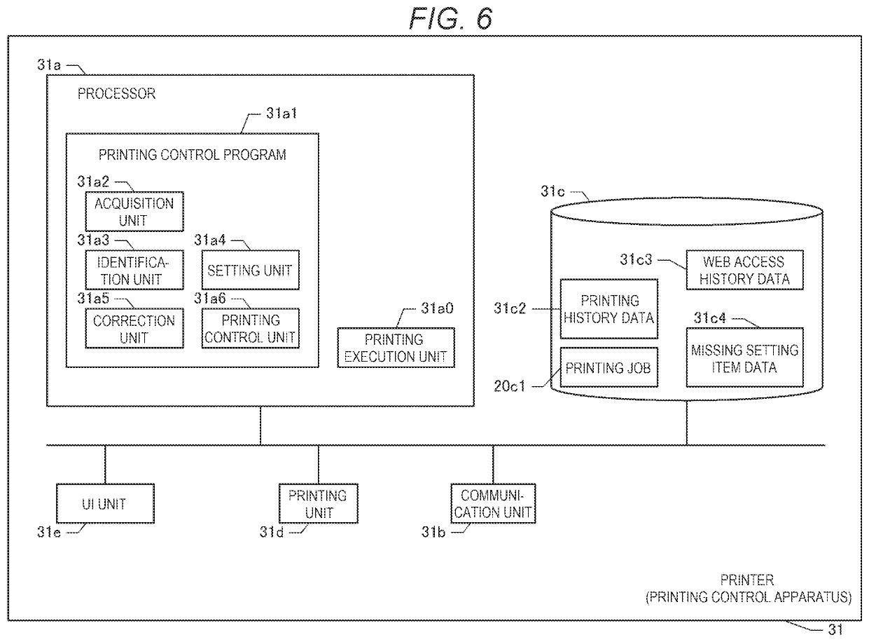

Next, a configuration of the printer 31 that also functions as the printing control apparatus will be described with reference to FIG. 6. The printer 31 includes a processor 31a, a communication unit 31b, a non-volatile memory 31c, a printing unit 31d, and a UI unit 31e. The processor 31a includes a CPU, a ROM, a RAM, and the like (not shown), and can control parts of the printer 31 by executing various programs stored in the non-volatile memory 3c.

The communication unit 31b includes a communication interface for communicating with an external device according to various communication protocols. The printer 31 can communicate with another apparatus via the communication unit 31b. The communication unit 31b may include an interface for communicating with various removable memories mounted on the printer 31.

The printing unit 31d is a portion for executing printing, and prints content on a printing medium. The printing method is not limited. Various methods such as an inkjet method and a toner method can be adopted. The printing unit 31d includes an actuator, various devices, sensors, drive circuits, mechanical components, and the like for executing printing on a printing medium. The printing unit 31d may implement various functions related to printing. For example, when implementing a finisher function, the printing unit 31d includes a mechanism that can execute finishing after printing. The term finishing refers to a function of bundling printed matters with staples, opening binding holes in the printed matters, or performing the binding.

The UI unit 31e includes at least any one of a touch panel display, various keys, switches, LEDs, and the like. The touch panel display includes a display panel that displays various pieces of information, for example, a status of the printer 31 and a remaining amount of ink, and a touch detection panel overlaid at the display panel, and detects a touch operation. The LED performs lighting or blinking display showing a status and the like of the printer 31. The processor 31a can acquire operation content of an administrator via the UI unit 31e.

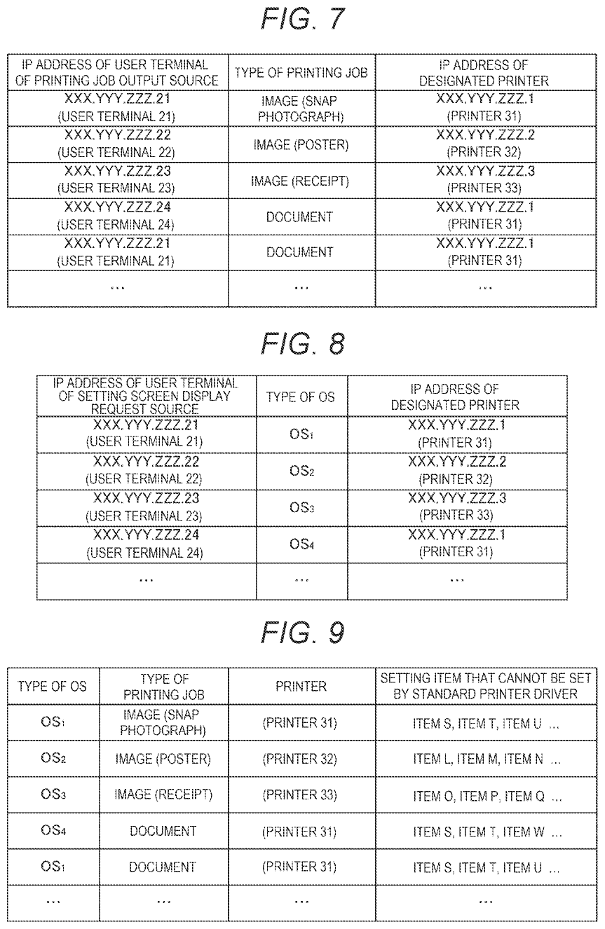

Various pieces of data is stored in the non-volatile memory 31c. For example, the printing job 20c1 transmitted from the user terminal can be temporarily stored. Further, in the embodiment, printing history data 31c2 and Web access history data 31c3 are accumulated during an operation process of the printing system in the non-volatile memory 31c. The printing history data 31c2 is data indicating history of printing instructed from each user terminal, and is used to identify a setting item that cannot be set by the standard printer driver of the user terminal (setting item missing in the standard printer driver) among setting items related to functions that can be used by a printer that executes printing. FIG. 7 shows an example of the printing history data 31c2. As shown in FIG. 7, an IP address of a user terminal of a printing job output source, a type of the printing job, and an IP address of a printer designated as a printer that executes printing are stored in association with one another in the printing history data 31c2. Details thereof will be described later.

The Web access history data 31c3 is data indicating history of printing setting screen display requests (to be described later) made from a user terminal. Similar to the printing history data 31c2, the Web access history data 31c3 is also used to identify a setting item that cannot be set by the standard printer driver of the user terminal (missing setting item) among setting items related to functions that can be used by a printer that executes printing. FIG. 8 shows an example of the Web access history data 31c3. As shown in FIG. 8, an IP address of a user terminal of a request source of a setting screen display request, a type of an OS of the user terminal, and an IP address of a printer designated as a printer of a request destination of the setting screen display request (a printer of a setting target) are stored in association with one another in the Web access history data 31c3. Details thereof will be described later.

Missing setting item data 31c4 is stored in advance in the non-volatile memory 30c. As shown in FIG. 9, a setting item that cannot be set by the standard printer driver of an OS among setting items of functions that can be executed by a printer is stored in association with each combination of a type of the OS of a user terminal, a type of a printing job, and a type of the printer. As will be described later, the missing setting item data 31c4 is referred to when a setting screen is displayed on a user terminal in response to the setting screen display request from the user terminal.

The processor 31a uses a function of a printing execution unit 31a0, and controls the printing unit 31d to execute printing based on the printing job 20c1 acquired via the print server to be described later. That is, the printing job 20c1 generated by any one of the user terminals and corrected by the function of the print server (addition of a setting item that cannot be set by the standard printer driver) is acquired from the print server, and the printing unit 31d is controlled to print content data based on an operation instruction based on the printing setting data included in the printing job 20c1. As a result, the printed matter is produced.

The processor 31a executes a printing control program 31a1 to cause the printer 31 to function as the print server. In the embodiment, the print server implements virtual printers using an internet printing protocol (IPP) corresponding to the printers 31, 32, and 33, and mediates between the user terminals 21, 22, 23, and 24 and the printers 31, 32, and 33 to execute printing. The printers 31, 32, and 33 may or may not correspond to the IPP.

When the printing control program 31a1 is executed, the processor 31a functions as an acquisition unit 31a2 that acquires a printing job from an external computer, an identification unit 31a3 that identifies a type of a program operating on the external computer, a setting unit 31a4 that displays a setting screen corresponding to the identified type and receives setting of the user via the setting screen, a correction unit 31a5 that corrects the printing job according to the received setting, and a printing control unit 31a6 that causes a printer to execute printing based on the corrected printing job.

Next, details of an operation among the print server, the user terminal, and the printer will be described.

### (2) Printing Control Processing

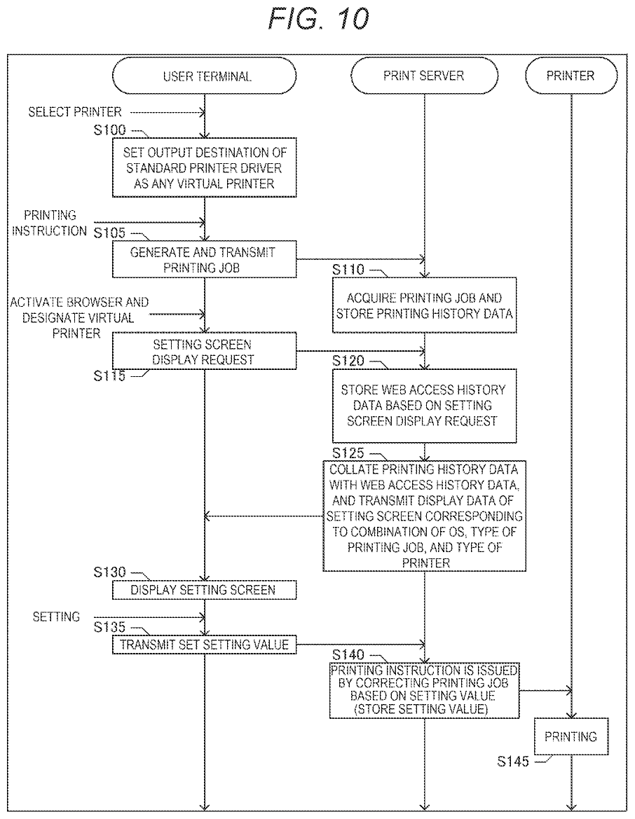

FIG. 10 is a sequence chart showing printing control processing. First, the user generates document data desired to be printed by using an application program in a user terminal used by the user (for example, the user terminal 21 is assumed). The user selects an output destination printer of a printing job that uses the standard printer driver of the OS. That is, the processor 20a of the user terminal 21 sets an output destination of the standard printer driver to a virtual printer selected by the user (step S100). Specifically, the processor 31a serving as the print server implements the virtual printers for the printers 31, 32, and 33 serving as real printers. The virtual printer is a printer compatible with the IPP protocol. As shown in FIG. 4, an IP address serving as the virtual printer is assigned to each of the printers 31, 32, and 33 in addition to an IP address serving as the real printer. In response to an inquiry as to whether there is a printer compatible with the IPP from the user terminal, the processor 31a responds with the virtual printer IP address of the printer 31, the virtual printer IP address of the printer 32, and the virtual printer IP address of the printer 33. Based on the response, the user terminal that makes the inquiry can recognize the three virtual printers described above as the printers compatible with the IPP. When the user prints content by using the standard printer driver 20a1 in the user terminal 21, the user terminal 21 uses the three virtual printers described above as options. The user can select a printer corresponding to a type of content that the user wants to print among the printers. The processor 20a of the user terminal 21 sets the selected printer (virtual printer) as the output destination.

Subsequently, when the user operates the user terminal 21 to issue the printing instruction, the processor 20a of the user terminal 21 transfers the generated document data to the standard printer driver 20a1 based on the application program, generates the printing job 20c1 based on the document data by using the standard printer driver 20a1, and transmits the printing job 20c1 to a virtual printer of the output destination (step S105). Here, the user sets a standard setting item that can be set by the standard printer driver 20a1, and issues the printing instruction. In response to the printing instruction, the user terminal 21 generates the printing job 20c1, and outputs the printing job 20c1 to the virtual printer selected by the user.

Subsequently, the print server (processor 31a) acquires the printing job 20c1 from the user terminal 21 serving as the external computer, and stores the printing history data 31c2 (step S110). That is, the processor 31a uses a function of the acquisition unit 31a2 to acquire the printing job 20c1 output to the virtual printer, and stores the IP address of the user terminal of the printing job output source and the IP address of the designated printer in the printing history data 31c2 shown in FIG. 7 based on the acquired printing job 20c1. Further, the processor 31a uses a function of the identification unit 31a3 to identify a type of the printing job, and stores the type in the printing history data 31c2 shown in FIG. 7. Specifically, the processor 31a refers to the setting items and the setting values included in the printing setting data of the printing job 20c1, and acquires the setting values such as a size and a color/monochrome of a printing medium. Further, the processor 31a identifies a main application of the designated printer based on a product number or the like of the printer. Based on the information, the processor 31a determines whether a type of the printing job is, for example, a document, a photograph, a poster, or a receipt, and stores a determination result in the printing history data 31c2.

In the embodiment, after the printing job 20c1 is output to a desired printer from the user terminal 21, the user operates the user terminal 21 to activate a program of a Web browser, and inputs an IP address of the printer (an IP address serving as a virtual printer) in order to display a setting screen of the printer on the user terminal 21. The user terminal transmits a setting screen display request for a setting screen of a printer corresponding to the input IP address to the IP address (step S115). When the Web browser has already been activated, there is no need to activate the Web browser again.

The processor 31a of the print server uses the function of the identification unit 31a3 to store the Web access history data 31c3 based on the setting screen display request (step S120). The processor 31a identifies a type of a program operating in the user terminal serving as the external computer (specifically, a type of an operating system (OS) of the user terminal). Therefore, in the embodiment, the type of the OS is identified based on access information from the browser of the user terminal 21 serving as the external computer. In the embodiment, the setting screen display request corresponds to the access information. Information indicating a type of the Web browser and a type of the OS of the user terminal is included in the setting screen display request. The information indicating the type of the OS includes a name, a version, and the like of the OS. The type of the OS is distinguished by the name and the version. The processor 31a can identify the type of the OS of the user terminal based on the setting screen display request. Further, the IP address of the user terminal of the request source and the IP address of the designated printer are included in the setting screen display request. The processor 31a stores the information included in the setting screen display request in association with one another as the Web access history data 31c3 as shown in FIG. 8.

Subsequently, the processor 31a of the print server uses a function of the setting unit 31a4, collates the printing history data 31c2 stored in step S110 with the Web access history data 31c3 stored in step S120, and transmits, to the user terminal, display data of a setting screen corresponding to a combination of the OS of the user terminal, the type of the printing job, and the type of the printer as a response to the setting screen display request described above (step S125). As shown in FIG. 9, the setting items that cannot be set by the standard driver of the OS but can be set by the output destination printer are listed up in advance corresponding to the combination of the type of the OS, the type of the printing job, and the type of the printer as the missing setting item data 31c4. The processor 31a transmits, to the user terminal, display data for displaying a setting screen on which setting of the listed-up setting items can be received.

The Web browser of the user terminal 21 that receives the display data displays the setting screen indicated by the display data on the display 20d based on the display data (step S130). In this way, the processor 31a can use the function of the setting unit 31a4 to display the setting screen on the Web browser of the user terminal 21 serving as the external computer. The setting items that can be set by the standard printer driver are different depending on a type of the OS. As in the embodiment, a setting screen for setting setting items of a printer that cannot be set by a standard driver of an OS is displayed on a user terminal corresponding to a combination of a type of the OS, a type of a printing job, and a type of the printer, whereby it is possible to guide the user such that functions of the printer can be fully set in any combination.

Subsequently, the user operates the input unit 20e of the user terminal 21 to set a desired setting item among the setting items displayed on the setting screen. The user terminal 21 transmits a set setting value to a virtual printer designated using a function of the Web browser (step S135).

When receiving the setting item and the setting value thereof from the user terminal 21, the processor 31a uses a function of the correction unit 31a5 to correct the printing job according to the received setting, and uses a function of the printing control unit 31a6 to cause the printer to execute printing based on the corrected printing job (step S140). That is, the processor 31a corrects the printing job by adding, to the printing job 20c1, the setting item that is a setting item that cannot be set by the standard printer driver and for which the user inputs a setting value, and the setting value thereof. Of course, when the user instructs that printing is performed without changing the setting value, the correction of the printing job is not required.

The processor 31a refers to the correspondence table as shown in FIG. 4, converts the IP address of the virtual printer of the output destination into the corresponding IP address of the real printer, and transmits the printing job 20c1 to the real printer. In step S140, the processor 31a stores the setting item and the setting value thereof transmitted from the user terminal 21 in step S135 in association with the combination in FIG. 9. The setting item and the setting value stored in this way are used to automatically apply the setting value to the setting item, correct the printing job, and execute printing when a printing job having the same combination (a combination of the OS, the printing job, and the printer) is received again.

Subsequently, the printer that receives the printing job transmitted in step S140 performs printing based on the received printing job 20c1 (step S145). That is, the printer prints content data by applying setting content of the printing setting data included in the printing job 20c1. The setting item that cannot be set by the standard printer driver may be included in the printing setting data. For example, although it is assumed that setting items corresponding to control instructions for the cutting mechanism of the roll paper and the peripheral devices cannot be set by the standard printer driver, if the user sets the setting items corresponding to the control instructions before step S135, the printer can control the cutting mechanism and the peripheral devices according to an instruction of the user.

As described above, according to the embodiment, even if the standard printer driver of the OS is used to perform printing, the user can cause the printer to perform printing using printer-unique functions.

After step S145 is executed, when the user operates the same user terminal 21 to issue a printing instruction of the same type of content to the same printer, the processor 20a of the user terminal 21 displays a setting screen of the standard printer driver, acquires setting of the user, generates the printing job, and transmits the generated printing job to the printer. Since the combination of the OS of the user terminal 21 of the output source of the printing job, the type of the printing job, and the type of the printer of the output destination is already stored in history, the print server (processor 31a) automatically applies the setting item that is stored in association with the combination and cannot be set by the standard printer driver and the setting value thereof, corrects the printing job, and transmits the printing job to the printer. By doing this, when the user operates the same user terminal 21 to issue a printing instruction of the same type of content as before to the same printer, it is possible to execute printing in which a setting value of a setting item is automatically applied without setting the setting item that cannot be set by the standard printer driver every time.

When the user wants to change the setting value already stored in step S140, the user activates the Web browser from the user terminal to input an IP address of an output destination printer that is one element of a combination for which the user wants to change setting, and causes a setting screen corresponding to a combination of the printer and an OS of the user terminal to be displayed. For example, as in the example of the user terminal 23 in FIGS. 7, 8, and 9, when only a receipt image is associated with the printer 33 as a printing job, the processor 31a displays, on the user terminal, a setting screen including setting items corresponding to a combination of an OS₃ that is an OS of the user terminal 23, the receipt image, and the printer 33. On the other hand, when a printing instruction for a different type of printing job is issued in the past to the same printer from the same type of OS, a different combination is stored. For example, the example in FIGS. 7, 8, and 9 shows that the user terminal 21 where OS₁ is installed prints both an image and a document in the printer 31. In such a case, the processor 31a provides, to the user terminal 21, display data for separately displaying a document setting screen and an image setting screen by a tab on the Web browser of the user terminal 21, and enables the user to immediately switch to a desired setting screen on the user terminal 21.

The setting screen is displayed in a form corresponding to a type of the printing job. For example, the setting items included in the setting screen may be changed according to a type of the printing job. Specifically, for example, even for a setting screen of the same printer, a setting screen obtained by excluding a setting item that is less likely to be set as printing setting of a photographic image is displayed when a type of the printing job is the photographic image, and a setting screen obtained by excluding a setting item that is less likely to be set as printing setting of a document is displayed when a type of the printing job is the document. Alternatively, according to a type of the printing job, a setting item that is likely to be set depending on a type of the printing job may be preferentially displayed by disposing the setting item at an upper portion of a setting screen, and the display priority may be lowered by disposing a setting item that is less likely to be set depending on a type of the printing job at a lower portion of the setting screen. By doing so, the user can easily find desired setting on the setting screen.

### (3) Other Embodiments

The embodiment described above is merely an example for implementing the present disclosure, and various other embodiments can be adopted. For example, the embodiment described above shows an example in which a processor of any printer also functions as the print server. Alternatively, of course, a computer separate from the printer may function as the print server.

The types of the printer exemplified in the embodiment described above are merely examples, and various types of other printers may be assumed. The printing medium is not limited to the paper, and various printing media such as cloth, ceramic, and resin may be assumed.

A timeout function may be provided in the printing control processing in FIG. 10. For example, after step S110, when a timer is operated and the setting screen display request in S115 is not received within a predetermined time, printing setting in the standard printer driver is used (without printing setting of printer-unique functions) to transmit the printing job received from the user terminal as it is to the printer, or the printing job is corrected using a default setting value to transmit the corrected printing job to the printer, whereby printing may be executed by the printer. The timer described above may be operated in a new combination not stored in the printing history data 31c2, the timer may not be operated in an already stored combination, and printing in which a setting value set in the past is applied to a setting item that cannot be set by the standard printer driver may be immediately executed in the combination.

In the embodiment described above, a list of setting items that cannot be set by the standard printer driver of the OS but can be set by the printer are stored for each combination of the type of the OS of the user terminal, the type of the printing job, and the type of the printer, but the list may be stored for each combination of the type of the OS of the user terminal and the type of the printer.

In the embodiment described above, an example is set in which the type of the program operating in the external computer, which is identified by the identification unit, is the type of the operating system of the external computer. Alternatively, for example, an application program that opens content of a printing target, or an application program that generates the content of the printing target may be identified. The present disclosure is not limited to generating the printing job by using the standard printer driver of the OS of the user terminal. When the printing job is generated using a printer driver included in the application program, a printer driver created by a third party, or the like, the program may be identified.

The setting screen may be any screen that enables setting for at least setting that cannot be performed when the printing instruction is issued on the user terminal by the user. The setting screen may be, for example, a screen not depending on a type of the printing job. The setting screen may change a setting value set using the standard printer driver of the OS. Further, there are no limitations on how the setting screen is displayed. For example, the setting screen may be displayed on a user terminal that generates the document data, or may be displayed on another terminal. The terminal that displays the setting screen may display the setting screen by using a browser, or may display the setting screen by using another program such as a messenger application.

The identification unit may issue a network search packet, and identify a type of a program (OS) of an external computer (user terminal) based on a response to the network search packet. The identification unit may identify a type of a program by another method for an external computer whose response to the network search packet does not exist.

The identification unit may perform identification based on content manually input by the user. For example, the identification unit may present the user with a plurality of options corresponding to types of programs, and identify a type of a program based on an option selected by the user. For example, in a case where the user sets an IP address of a desired printer (virtual printer) in the Web browser in the user terminal, the print server first displays options of types of programs on the Web browser of the user terminal. When a type of a program is selected, the type of the program is acquired. The print server displays, on the user terminal, a setting screen where a missing setting item can be set according to a type of the program, a type of the printer (and a type of the printing job). The identification unit may, after automatically performing identification, manually receive a correction from the user to perform identification again.

When the user wants to change a once set setting value for a setting item that cannot be set by the standard printer driver, operation panels of the UI units 30e and 31e of the printers can be operated to perform the change. When an operation panel of a printer is operated, the printer displays a list for each combination of a type of the operated printer, a type of an OS of a user terminal, and a type of a printing job, and causes the user to select a combination for which the user wants to change setting. The printer may display a setting screen including setting items corresponding to the selected combination (a setting screen the same as the screen displayed on the Web browser in the embodiment described above).

When a user terminal is a portable terminal such as a smartphone or a tablet, a two-dimensional code for displaying a setting screen on the user terminal is displayed on a screen of a printer, and the two-dimensional code is imaged by a camera of the user terminal by the user, whereby the setting screen corresponding to a combination of an OS of the user terminal, the printer, and content of a printing job (a setting screen the same as the screen displayed on the Web browser in the embodiment described above) may be displayed on the user terminal.

When a user terminal is a personal computer OS, the print server may give a notification of link information for opening a setting change screen by email or the like. The user operates the user terminal to click the link, whereby the setting screen can be displayed on the Web browser.

Further, the present disclosure is also applicable as a program or a method executed by a computer. That is, the present disclosure is also established as a disclosure of a method for producing a printed matter, the method including: acquiring a printing job from an external computer; identifying a type of a program operating in the external computer; displaying a setting screen corresponding to the identified type; receiving setting of a user via the setting screen; and causing a printer to produce the printed matter based on the printing job corrected according to the received setting.

The present disclosure is also established as a disclosure of a printing control program that causes a computer to function as: an acquisition unit that acquires a printing job from an external computer; an identification unit that identifies a type of a program operating in the external computer; a setting unit that displays a setting screen corresponding to the identified type and receives setting of a user via the setting screen; a correction unit that corrects the printing job according to the received setting; and a printing control unit that causes a printer to execute printing based on the corrected printing job.

The system, the program, and the method as described above may be implemented as a single apparatus or may be implemented by using components provided in a plurality of apparatuses, and include various forms. Further, the present disclosure may be modified appropriately, and for example, a part is designed to be software and a part is designed to be hardware. Furthermore, the disclosure is also established as a storage medium of a program that controls the system. Of course, the storage medium of the program may be a magnetic storage medium or a semiconductor memory, and any storage medium to be developed in the future can be considered in exactly the same way. For example, the function of the printer driver may be included in an OS or an application program and integrated.

What is claimed is:

1. A printing control apparatus comprising:
an acquisition unit configured to acquire a printing job from an external computer;
an identification unit configured to identify a type of a program operating in the external computer;
a setting unit configured to display a setting screen corresponding to the identified type, and receive setting of a user via the setting screen;
a correction unit configured to correct the printing job according to the received setting; and
a printing control unit configured to cause a printer to execute printing based on the corrected printing job.

2. The printing control apparatus according to claim 1, wherein
the identification unit identifies the type of the program based on access information from a browser of the external computer.

3. The printing control apparatus according to claim 1, wherein
the identification unit issues a network search packet, and identifies the type of the program based on a response to the network search packet.

4. The printing control apparatus according to claim 1, wherein
the identification unit presents the user with a plurality of options corresponding to the type of the program, and identifies the type of the program based on an option selected by the user.

5. The printing control apparatus according to claim 1, wherein
the type of the program operating in the external computer is a type of an operating system of the external computer.

6. The printing control apparatus according to claim 1, wherein
the setting unit causes a browser of the external computer to display the setting screen.

7. The printing control apparatus according to claim 1, wherein
the identification unit also identifies a type of the printing job, and
the setting unit causes the setting screen also corresponding to the type of the printing job to be displayed.

8. The printing control apparatus according to claim 1, further comprising:
the printer.

9. A method for producing a printed matter, the method comprising:
acquiring a printing job from an external computer;
identifying a type of a program operating in the external computer;
displaying a setting screen corresponding to the identified type;
receiving setting of a user via the setting screen; and
causing a printer to produce a printed matter based on the printing job corrected according to the received setting.

10. A non-transitory computer-readable storage medium storing a printing control program for causing a computer to function as:
an acquisition unit configured to acquire a printing job from an external computer;
an identification unit configured to identify a type of a program operating in the external computer;
a setting unit configured to display a setting screen corresponding to the identified type, and receive setting of a user via the setting screen;
a correction unit configured to correct the printing job according to the received setting; and
a printing control unit configured to cause a printer to execute printing based on the corrected printing job.
